(19) United States
(12) Patent Application Publication
(10) Pub. No.: US 2005/0068927 A1
(43) Pub. Date: Mar. 31, 2005

(54) Method of transmitting data through local area network

(75) Inventors: Tai-Shui Ho, Taipei Hsien (TW); Shih-Kuang Tsai, Taipei Hsien (TW); Xiao-Qin Yu, Shanghai City (CN); Wen-Jiang Qing, Shanghai City (CN)

Correspondence Address: BACON & THOMAS, PLLC, 625 SLATERS LANE, FOURTH FLOOR, ALEXANDRIA, VA, 22314, US

(73) Assignee: Inventec Appliances Corp., Taipei Hsien (TW)

(21) Appl. No.: 10/671,578

(22) Filed: Sep. 29, 2003

(51) Int. Cl. H04Q 7/24

(52) U.S. Cl. 370/338

(57) ABSTRACT

This invention discloses a method of transmitting data through Local Area Network by abandoning the Transmission Control Protocol/Internet Protocol (TCP/IP) to eliminate the Address Resolution Protocol (ARP) and avoid unnecessary delay and communication flow. The present invention also abandons the concept of TCP/IP address, so that it is not necessary to maintain the huge TCP/IP address database in wireless LAN in order to implement the gapless roaming and reduce packet conflict during the transmission process by defining a smaller capacity for the data packet head in the high-speed wireless LAN standard IEEE 802.11 protocol.

### BACKGROUND OF THE INVENTION

1. Field of the Invention

The present invention relates to a method of transmitting data, more particularly to a fast transmission method through a local area network (LAN).

2. Description of the Related Art

In September of 1999, the Institute of Electrical and Electronics Engineers (IEEE) established the high-speed wireless local area network standard IEEE 802.11, which refers to a communication protocol operated under the wireless LAN environment. At present, the wireless LAN operation follows this standard, and the IEEE 802.11 is divided into different types and identified by an English alphabet such as the 802.11a, 802.11b, and 802.11g according to different security levels and transmission speeds.

The specification of the high-speed wireless LAN standard IEEE 802.11b was developed with an original intention of enhancing the mobility of corporate intranet communications, saving the cost of installing the cable LAN, and leveraging the limited network resources more flexibly. Therefore, the IEEE 802.11b is a technology designed for a long-distance or high-speed data transmission via modem. Like the “Bluetooth” wireless transmission technology, the IEEE 802.11b wireless data transmission technology adopts the same transmission medium, which accomplishes data transmission by radio wave technology. Therefore, the data transmission of the IEEE 802.11b also has the all-purpose transmission characteristics. In other words, the IEEE 802.11b does not have the angle or direction limitations, and can penetrate obstacles to complete the data transmission task.

From the above description, it is known that the IEEE 802.11b is very suitable for being used in the office environment. We only need to construct a wireless access point (AP) in a company to connect any computer having an installed wireless LAN card within the effective emission range, and thus attaining the purpose of network connection. In the meantime, the IEEE 802.11b wireless transmission technology has a transmission distance up to 100 meters, and the maximum transmission rate is 11 Mbps. If the IEEE 802.11b works together with a wave amplifier, the effective transmission can reach up to 300 meters, which is more than enough for the general network connection and data transmission jobs. As to the mobile users, it can also overcome the limitation of the traditional cable network. Based on the aforementioned features, the IEEE 802.11b is very suitable for the layout by extending the original established cable LAN or completely replacing the current cable LAN, because the functions are exactly the same as those for the cable LAN.

As its name suggests, the access point (commonly called wireless base station or wireless accessor) serves as a bridge for the communications between a traditional cable LAN and a wireless LAN. Therefore, any computer with an installed wireless network card can share the cable LAN or even WAN through the wireless access point. Furthermore, the wireless access point also concurrently has the network administration function, which can control and manage a computer with an installed wireless network card.

In the high-speed wireless LAN standard IEEE 802.11 protocol/architecture, the most popular, economic, and simplest way of connecting a radio frequency (RF) network and a cable network is to set a mobile computer as a workstation of the Transmission Control Protocol/Internet Protocol (TCP/IP) and handle the RF network as an extension of the cable network. A great advantage of such method is that it requires very little development work, but just applies the existing TCP/IP technology and uses the wireless access point of the high-speed wireless LAN standard 802.11 as the medium access control (MAC) sublayer. Although such method is very simple, the wireless network uses the original transmission method of the cable network and has the following limitations due to the wireless network having a more complicated RF broadcasting environment than the cable network:

1. The TCP/IP acts as the most popular available certified open standard in the LAN and Internet. It is regarded as a cable network design, but did not take the special requirements of the wireless network (such as RF) into consideration.

2. The header of TCP/IP generally consists of 20˜40 bytes. It is recommended to use less byte for the header in order to use the wideband better and reduce the packet conflict in the RF wireless network.

3. The TCP/IP relies on the precise confirmation mechanism and the Address Resolution Protocol (ARP), which is suitable for general cable networks only, but cannot maximize the high performance in the data collection environment. More particularly, the ARP makes use of the broadcast information to establish a channel between the cable network and wireless network, which will cause unnecessary delay and communication flow.

4. In the wireless network, the specification of the IEEE 802.11 is also called Wireless Ethernet, because the basic technical principles of the IEEE 802.11 and the IEEE 802.3 are very similar. The specification of the IEEE 802.11 has defined a physical layer in the wireless LAN architecture and a Medium Access Control (MAC) sublayer in the data link layer. The data access method defined in the MAC adopts the CSMA/CA (Carrier Sense Multiple Access with Collision Avoidance) instead of the IEEE 802.3 CSMA/CD (Carrier Sense Multiple Access with Detection). The IEEE 802.3 CSMA/CD uses the detecting collision method to transmit frames, because it is much more difficult to detect the collision situation of the wireless network in the air than that of the cable network. Therefore, the IEEE 802.11 adopts the CSMA/CA data access method to reduce the occurrence of collision during the data transmission.

In the carrier sense mode of the CSMA/CA, the transmitting end will “wait first” for an interval frame space (IFS). If no frame transmission is detected, the transmitting end will send out the packet. If the transmission of the packet in this channel has been detected from the very beginning, the transmitting end will wait till the channel is clear, and then wait for a Back Off time, and re-enter into the channel competing mode. At that time, the priority of using such channel will be raised automatically under the competing mode of the transmitting end which has been backed off, so that it can avoid the difficult situation for some transmitting ends being unable to obtain the right of using the channel.

However, the congestion control algorithm of the TCP/IP (such as the CSMA/CA) is a major factor of deteriorating the system performance, particularly when the TCP/IP adopts the “Back Off” algorithm to overcome such problems. The transmission rate will be greatly lowered.

5. In the wireless network, besides the congestion and conflict of data packets, the RF system will be affected by other interference and wireless broadcasting environment. For example, the radio wave frequencies of both IEEE 802.11b and “Bluetooth” use the Industrial Scientific Medical Band (ISM), which is open mainly for industrial, scientific, and medical organizations to use the 2.4 GHz high frequency range. Therefore, if the 802.11b and the “Bluetooth” technologies are used in the same time within the range of several meters, then interference with each other will occur, and even the so-called “Blocking Station” will occur. (When a communication of the same frequency interferes, it results a situation of totally incapable of communicating). In addition, the interference by radio frequency signal and blocking of the blind spots will disconnect users from the server, so that users have to login again to continue their applications.

6. The TCP/IP is unable to process the roaming between sub-networks. To solve the roaming problem, the mobile IP technology must be used. However, the mobile IP will greatly increase the complexity and communication flow of the network, of which we do not want.

### SUMMARY OF THE INVENTION

In view of the description above, since the wireless network uses the original transmission method of the cable network, it will have many restrictions. The inventor of this invention conducted extensive researches and experiments and finally invented a method of transmitting data through local area network. The concepts of the Address Resolution Protocol (ARP) and the Transmission Control Protocol/Internet Protocol (TCP/IP) in a wireless LAN are eliminated and the data packet head is defined into a smaller capacity in the high-speed wireless LAN standard IEEE 802.11 protocol to facilitate the wideband application and reduce packet conflict during the transmission process, and also avoid unnecessary delay and communication flow. In the wireless LAN, it is not necessary to maintain the huge TCP/IP address database in order to implement the gapless roaming.

The primary objective of the present invention is to provide a method of transmitting data through Local Area Network by abandoning the Transmission Control Protocol/Internet Protocol (TCP/IP) to eliminate the Address Resolution (ARP) and avoid unnecessary delay and communication flow. The present invention also abandons the concept of TCP/IP address, so that it is not necessary to maintain the huge TCP/IP address database in wireless LAN in order to implement the gapless roaming and reduce packet conflict during the transmission process by defining a smaller capacity for the data packet head in the high-speed wireless LAN standard IEEE 802.11 protocol.

### DETAILED DESCRIPTION OF THE PREFERRED EMBODIMENTS

This invention relates to a method of transmitting data through Local Area Network by abandoning the Transmission Control Protocol/Internet Protocol (TCP/IP) to eliminate the Address Resolution Protocol (ARP) and avoid unnecessary delay and communication flow. The present invention also abandons the concept of TCP/IP address, so that it is not necessary to maintain a huge TCP/IP address database in the wireless LAN in order to implement gapless roaming and reduce packet conflict during the transmission process by defining a smaller capacity for the data packet head in the high-speed wireless LAN standard IEEE 802.11 protocol.

If there is a cable network and a wireless network in the space of the LAN at the same time, then the cable network will still use the traditional TCP/IP protocol, and the wireless network will use the optimized 802.11 protocol to maximize the advantages and system performance of the cable network and the wireless network and provide an excellent communication for the specific data collecting terminal. In particular, the improved confirmation mechanism after removing the Address Resolution Protocol (ARP) as shown in the following table gives a better system performance:

TABLE 1
Information and data transmission of the server and mobile unit

| 802.11-TCP/IP | 802.11 Optimized |
|---|---|
| 1)−>ARP request | 1)−>message |
| 2)<−ARP response | 2)<−Ack |
| 3)−>message | 3)<−data |
| 4)<−Ack | 4)−>Ack |
| 5)<−ARP request | |
| 6)−>ARP response | |
| 7)<−data | |
| 8)−>Ack | |

From the above table, the improved confirmation mechanism greatly reduces the number of confirmation messages, and greatly improves the transmission delay and communication flow caused by confirmation. The smaller data saturated high-performance high-speed confirmation mechanism can avoid the complicated congestion control algorithm of the TCP/IP, and thus enhancing the system performance.

From the description above, this invention can greatly enhance the transmission speed of the wireless network, which has at least 5 advantages as listed below:

1. Smaller data flow and efficient confirmation mechanism improves the system response time, enhances the data flow, and eliminates unnecessary communication flow.

2. It does not require a complicated congestion control algorithm to have a better performance in the deteriorated and blocked area of the wireless network or areas with noises.

3. Due to the design of the data packet head in the wireless communication environment, the wireless wideband resources can be used in a better way.

4. Without affecting system performance or increasing cost, a mall area gapless roaming is accomplished to avoid he complicated mobile IP technology.

5. The interoperability between the 802.11 equipment and the TCP/IP equipment.

While the invention has been described by means of specific embodiments, numerous modifications and variations could be made thereto by those skilled in the art without departing from the scope and spirit of the invention set forth in the claims.

1. A method of transmitting data through local area network (LAN), comprising the steps of:
abandoning a Transmission Control Protocol/Internet Protocol (TCP/IP) in a wireless LAN to eliminate the concept of an Address Resolution Protocol (ARP); and
defining a smaller capacity for a data packet head in the high-speed wireless LAN standard IEEE 802.11 protocol.
